(19) United States
(12) Patent Application Publication
(10) Pub. No.: US 2026/0027829 A1
(43) Pub. Date: Jan. 29, 2026

(54) CLEANING LIQUID PENETRATION DEVICE AND INKJET RECORDING APPARATUS

(71) Applicant: KYOCERA Document Solutions Inc., Osaka (JP)

(72) Inventors: Yosuke KATAYAMA, Osaka (JP); Yasutaka INUI, Osaka (JP); Yuko YANO, Osaka (JP); Motonobu SUGIMOTO, Osaka (JP)

(73) Assignee: KYOCERA Document Solutions Inc., Osaka (JP)

(21) Appl. No.: 19/273,504

(22) Filed: Jul. 18, 2025

(30) Foreign Application Priority Data
Jul. 23, 2024 (JP) 2024-117796

(51) Int. Cl. B41J 2/165

(52) U.S. Cl. CPC B41J 2/16552; B41J 2/16511; B41J 2002/16558

(57) ABSTRACT

A cleaning liquid penetration device includes an impregnated member and a holding member. The impregnated member is impregnated with a cleaning liquid. The holding member holds the impregnated member in a planar shape by a planer surface facing a nozzle surface of an inkjet head, and brings the planar-held portion of the impregnated member into contact with the nozzle surface. The holding member is more flexible than the nozzle surface.

### INCORPORATION BY REFERENCE

This application is based on and claims the benefit of priority from Japanese patent application No. 2024-117796 filed on Jul. 23, 2024 which is incorporated by reference in its entirety.

### BACKGROUND

The present disclosure relates to a cleaning liquid penetration device and an inkjet recording apparatus.

In an inkjet recording apparatus using water-based ink, moisture evaporates from the ink in a nozzle and a viscosity of the ink increases while printing is not executed, and there is a possibility that ejection failure or clogging occurs. Therefore, a technique for removing the ink with increased viscosity has been studied. For example, there is a nozzle cleaning device provided with a cleaning liquid tank filled with cleaning liquid for dissolving deposits adhering to a functional liquid discharge port, a cleaning liquid tank lifting means for lifting and lowering at least one of a functional liquid droplet ejection head and the cleaning liquid tank so as to immerse the nozzle surface of the functional liquid droplet ejection head in the cleaning liquid, and a wiping member for contacting the functional liquid ejection port immersed in the cleaning liquid in the cleaning liquid tank and removing the deposits on the functional liquid ejection port.

However, in the above-described configuration, since the whole cleaning liquid in the cleaning liquid tank is contaminated by the immersed nozzle surface, the contamination is progressing when the immersion is repeated. Therefore, it is necessary to change the cleaning liquid periodically, and a large amount of cleaning liquid is consumed.

### SUMMARY

A cleaning liquid penetration device according to the present disclosure includes an impregnated member and a holding member. The impregnated member is impregnated with a cleaning liquid. The holding member holds the impregnated member in a planar shape by a planer surface facing a nozzle surface of an inkjet head, and brings the planar-held portion of the impregnated member into contact with the nozzle surface. The holding member is more flexible than the nozzle surface.

An inkjet recording apparatus according to the present disclosure includes the cleaning liquid penetration device, the inkjet head; and a maintenance device which removes ink penetrated with the cleaning liquid by the cleaning liquid penetration device from the nozzle surface of the inkjet head.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a front view schematically showing an internal structure of the inkjet recording apparatus according to the embodiment of the present disclosure.

FIG. 3 is a front view schematically showing a head unit and a maintenance device according to the embodiment of the present disclosure.

FIG. 4 is a plan view schematically showing the head unit and a wipe unit according to the embodiment of the present disclosure.

FIG. 5 is a plan view schematically showing a cap unit according to the embodiment of the present disclosure.

FIG. 6 is a cross-sectional view showing an inkjet head according to the embodiment of the present disclosure.

FIG. 7 is a bottom view showing the inkjet head according to the embodiment of the present disclosure.

FIG. 8A to FIG. 8H are front views showing an operation of the maintenance device according to the embodiment of the present disclosure.

FIG. 9 is a right side view schematically showing a cleaning liquid supply device according to the embodiment of the present disclosure.

FIG. 10 is a right side view schematically showing the cleaning liquid supply device according to the embodiment of the present disclosure.

FIG. 11 is a right side view schematically showing a cleaning liquid penetration device according to a modified example of the embodiment of the present disclosure.

FIG. 12 is a right side view schematically showing a cleaning liquid penetration device according to a modified example of the embodiment of the present disclosure.

### DETAILED DESCRIPTION

Hereinafter, with reference to the drawings, an inkjet recording apparatus 1 according to one embodiment of the present disclosure will be described.

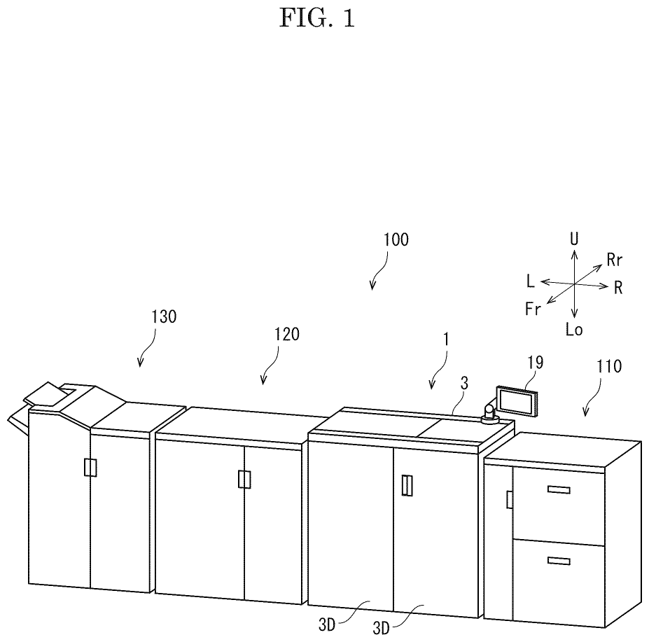

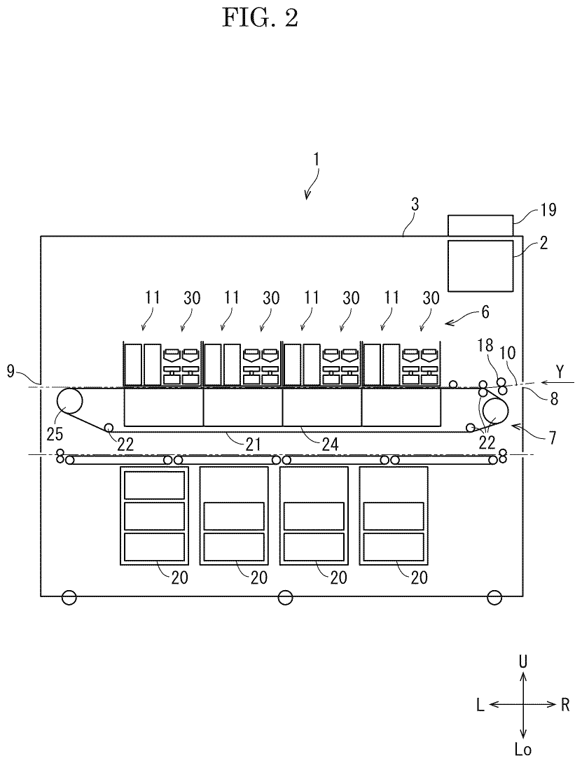

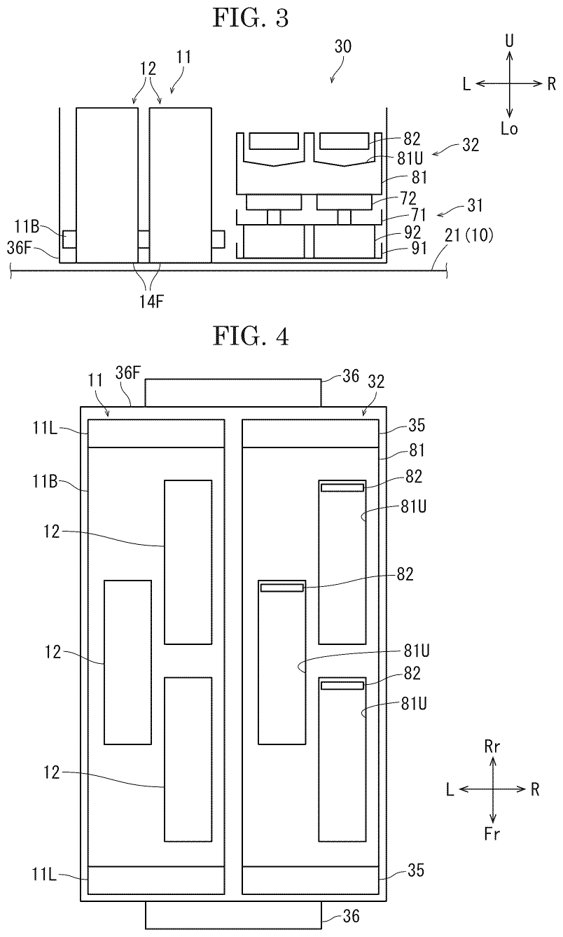

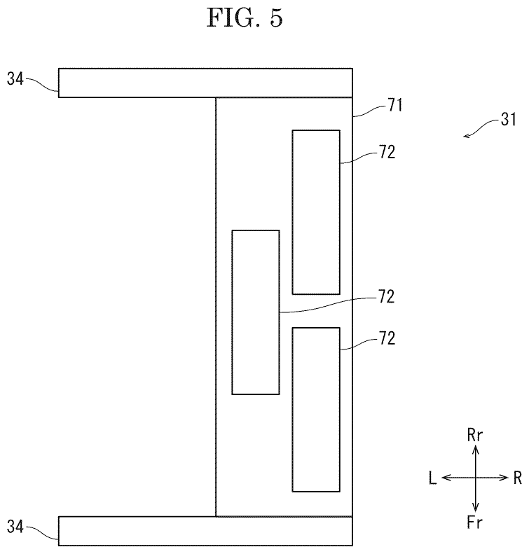

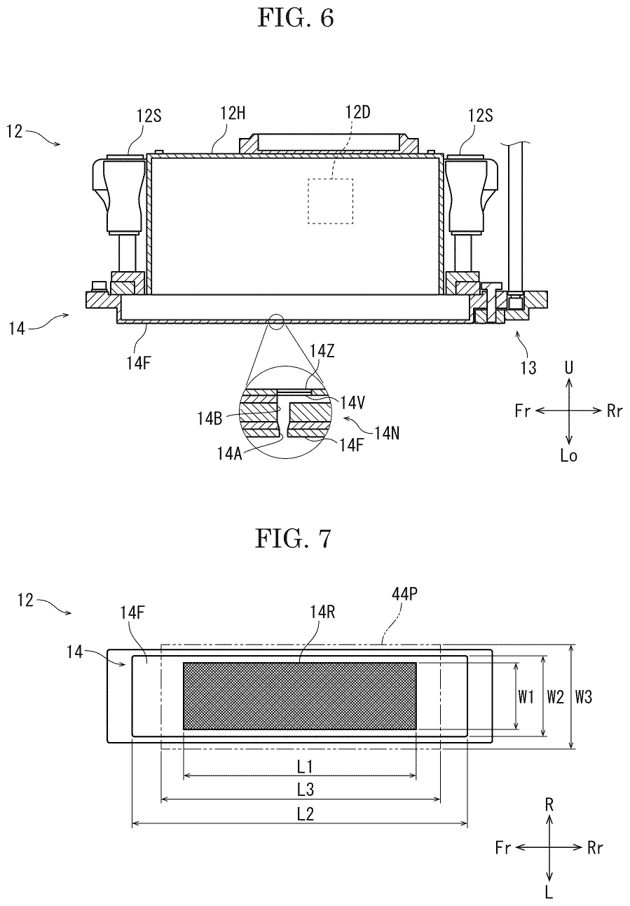

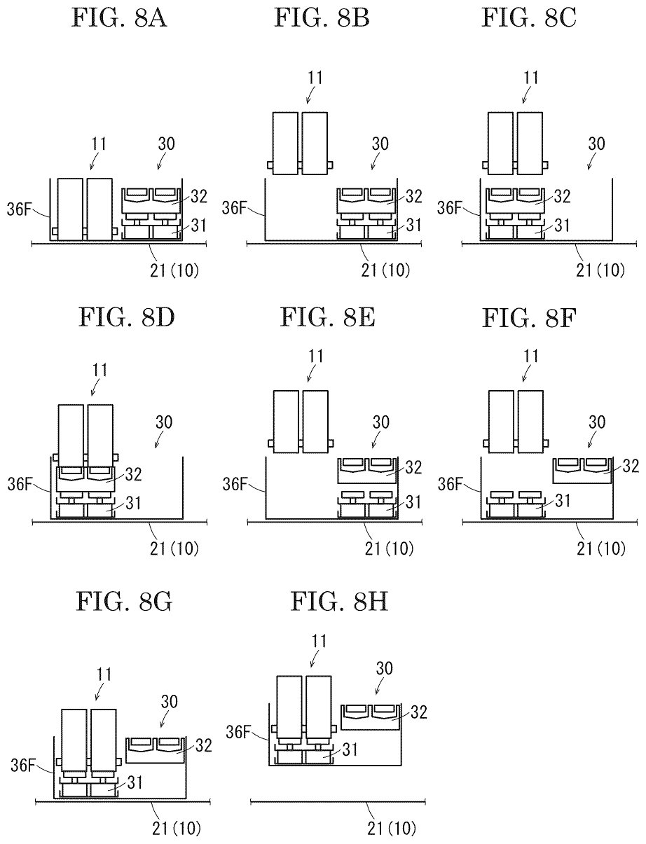

FIG. 1 is a perspective view showing an appearance of the image forming system 100. FIG. 2 is a front view schematically showing an internal structure of the inkjet recording apparatus 1. FIG. 3 is a front view schematically showing a head unit 11 and a maintenance device 30. FIG. 4 is a plan view schematically showing the head unit 11 and a wipe unit 32. FIG. 5 is a plan view schematically showing a cap unit 31. FIG. 6 is a cross-sectional view showing an inkjet head 12. FIG. 7 is a bottom view showing an inkjet head 12. FIG. 8A to FIG. 8H are front views showing an operation of the maintenance device 30. Hereinafter, the front side of the paper plane on which FIG. 2 is drawn is set to the front side of the inkjet recording apparatus 1, and the left-and-right direction is described with reference to the direction when the inkjet recording apparatus 1 is viewed from the front side. In each figure, U, Lo, L, R, Fr, and Rr indicate the upper, lower, left, right, front, and rear, respectively.

The image forming system 100 (see FIG. 1) includes a sheet feeding apparatus 110, an inkjet recording apparatus 1, a drying apparatus 120, and a post-processing apparatus 130. The sheet feeding apparatus 110 stores several thousand of sheets S, and feeds the sheet S to the inkjet recording apparatus 1. The inkjet recording apparatus 1 forms an image on the sheet S by an inkjet method. The drying apparatus 120 heats the sheet conveyed from the inkjet recording apparatus 1, and dries ink. The post-processing apparatus 130 performs post-processing such as drilling, stapling, and folding on the sheet S.

The inkjet recording apparatus 1 (see FIG. 2) includes a box-shaped body housing 3. In the center portion of the inside of the body housing 3, a conveying unit 7 which attracts the sheet S and conveys it in the Y direction is provided. Above the conveying unit 7, an image forming unit 6 which forms an image by ejecting the ink is provided. On the right surface of the body housing 3, a sheet feeding port 8 through which the sheet S is received from the sheet feeding apparatus 110 is provided. On the left side surface of the body housing 3, a discharge port 9 through which the sheet S on which the image is formed is discharged to the drying apparatus 120 is provided. Inside the body housing 3, a conveyance path 10 is provided from the sheet feeding port 8 to the discharge port 9 through a gap between the conveying unit 7 and the image forming unit 6. A registration roller 18 is provided on the upstream side of the conveying unit 7 in the conveyance direction Y.

The conveying unit 7 includes an endless conveying belt 21 and a suction part 24. The conveying belt 21 has a large number of air holes (not shown), and is wound around a driving roller 25 and a driven roller 22. The upper surface of the suction part 24 has a large number of air holes (not shown), and is in contact with the inner surface of the conveying belt 21. The suction part 24 sucks air through the air holes of the conveying belt 21 and the air holes of the suction part 24, so that the sheet S is attracted to the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed.

The image forming unit 6 includes a plurality (in this embodiment, four) of head units 11. The head unit 11 (see FIG. 3, FIG. 4) includes one or more inkjet heads 12 (in the present embodiment, three). Ink containers 20 filled with the black, cyan, magenta, and yellow ink are connected to the respective head units 11.

The inkjet head 12 (see FIG. 6) includes a rectangular parallelepiped housing 12H whose longitudinal direction is along the front-and-rear direction, a nozzle plate 14 provided at the bottom of the housing 12H, and a socket 12S to which a pipe for supplying the ink is connected. The nozzle plate 14 is provided with a large number of nozzles 14N arranged in the front-and-rear direction. The nozzle 14N includes a branch channel 14B branched from the downstream side of the socket 12S, and an ejection port 14A provided on a nozzle surface 14F which is the lower surface of the nozzle plate 14. A diaphragm 14V also serves as a part of the inner wall of the branch channel 14B. The diaphragm 14V is provided with a pressurizing element 14Z. As the pressurizing element 14Z, a piezoelectric element, an electrostatic actuator, a heater or the like are used. A driving circuit 12D for driving the pressurizing element 14Z is connected to the pressurizing element 14Z.

The nozzle surface 14F is rectangular whose longitudinal direction is along the front-and-rear direction. A large number of ejection ports 14A are provided in a rectangular region 14R narrower than the entire nozzle surface 14F. Specifically, a length L1 in the front-and-rear direction of the region 14R provided with the ejection ports 14A of the nozzle surface 14F is shorter than a length L2 in the front-and-rear direction of the nozzle surface 14F. A width W1 of the region 14R in the left-and-right direction is narrower than a width W2 of the nozzle surface 14F in the left-and-right direction. The shape of the region 14R may be a trapezoid, a parallelogram, or the like.

A control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), EEPROM (Electrically Erasable Programmable Read Only Memory), and the like. The arithmetic part reads the control program stored in the storage part and executes various processes. The control part 2 may be implemented by an integrated circuit that does not use software.

A display operation part 19 is provided on the upper portion of the body housing 3 (see FIG. 1, FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with the operation detected by the touch panel and the keypad.

The basic image forming operation of the inkjet recording apparatus 1 is as follows. When an image forming job is inputted to the inkjet recording apparatus 1 from the display operation part 19 or an external computer, the sheet feeding apparatus 110 feeds the sheet S to the conveyance path 10 through the sheet feeding port 8, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21, and conveys the sheet S in the Y direction. The ink is ejected from the nozzle to form an image on the sheet S. The sheet S on which the image is formed is conveyed to the drying apparatus 120 through the discharge port 9.

[Maintenance Device] Next, a maintenance device 30 will be described. Since the four head units 11 have the same configuration and the four maintenance devices 30 have the same configuration, one head unit 11 and one maintenance device 30 disposed on the right side of the head unit 11 will be described below.

The head unit 11 includes a head base 11B (see FIG. 3 and FIG. 4) which supports the inkjet heads 12. On the head base 11B, the three inkjet heads 12 are provided in a staggered pattern.

The maintenance device 30 (see FIG. 3) is provided on the lateral side (in this embodiment, on the right side). The maintenance device 30 includes a cap unit 31, and a wipe unit 32.

[Cap Unit] The cap unit 31 (see FIG. 3 and FIG. 5) is provided with the same number (in this embodiment, three) of caps 72 as the inkjet heads 12 provided in the head unit 11. The three caps 72 are arranged in a staggered pattern in the same manner as the inkjet heads 12.

[Wipe Unit] The wipe unit 32 (see FIG. 3 and FIG. 4) includes a waste liquid tray 81, and a cleaning member 82. The waste liquid tray 81 is provided with the same number of recesses 81U as the inkjet heads 12 provided in the head unit 11. The recesses 81U are arranged in a staggered pattern in the same manner as the inkjet heads 12. The cleaning member 82 is provided in each of the recesses 81U. The cleaning member 82 is, for example, a blade made of rubber. The waste liquid tray 81 includes a driving part (not shown) for sliding the cleaning member 82 along the nozzle surface 14F. The waste liquid tray 81 is placed on the plurality of caps 72. In other words, the wipe unit 32 is placed on the cap unit 31. The head unit 11 is provided with a cleaning liquid supply device 13 (see FIG. 6) for supplying a cleaning liquid F to the nozzle surface 14F.

[Head Lifting Device] Head lifting devices 11L (see FIG. 4) are provided on the front and rear sides of the head base 11B, respectively. The head lifting device 11L is constituted of, for example, a ball screw, a belt driving device, and the like. The head lifting devices 11L lift and lower the head unit 11 between an image forming position and a retracted position. The image forming position (see FIG. 8A) is a position where a distance between the conveyance path 10 (the upper surface of the conveying belt 21) along which the sheet is conveyed and the nozzle surface 14F is a predetermined distance suitable for the image formation. The image forming position is a lower limit of the lifting range of the head unit 11 by the head lifting devices 11L. The retracted position (see FIG. 8B) is a position where the head unit 11 does not interfere with the wipe unit 32 when the cap unit 31 and the wipe unit 32 are slid using a cap sliding device 34 described later. The retracted position is an upper limit of the lifting range of the head unit 11.

[Cap Sliding Device] The cap sliding devices 34 (see FIG. 5) are provided on the front and rear sides of the frame 71 of the cap unit 31, respectively. The cap sliding device 34 is constituted of, for example, a ball screw, a belt driving device, and the like. The cap sliding devices 34 slide the cap unit 31 to a home position and a maintenance position. The home position (see FIG. 8A) is a position on the right side of the head unit 11 positioned at the image forming position. The maintenance position (see FIG. 8F) is a position below the head unit 11 positioned at the retracted position.

[Wipe Lifting Device] Wipe lifting devices 35 (see FIG. 4) are provided on the front and rear sides of the waste liquid tray 81 of the wipe unit 32, respectively. The wipe lifting device 35 is constituted of, for example, a cam mechanism, a ball screw, or the like. The wipe lifting devices 35 lift and lower the wipe unit 32 to a contact position where the waste liquid tray 81 is in contact with the caps 72 (see FIG. 8B) and a separated position where the waste liquid tray 81 is separated upward by a predetermined distance from the caps 72 (see FIG. 8E).

[Unit Lifting Device] The head lifting devices 11L, the cap sliding devices 34, and the wipe lifting devices 35 are attached to a frame body 36F. In other words, the head unit 11 is supported by the frame body 36F via the head lifting devices 11L. The cap unit 31 is supported by the frame body 36F via the cap sliding devices 34. The wipe unit 32 is supported by the frame body 36F via the wipe lifting devices 35.

Unit lifting devices 36 are provided at the front and rear of the frame body 36F. The unit lifting devices 36 are supported by the body housing 3. The unit lifting device 36 is constituted of, for example, a ball screw, a belt driving device, and the like, and lifts and lowers the frame body 36F. That is, the unit lifting devices 36 lift and lower the head unit 11 and the maintenance device 30 collectively. The unit lifting devices 36 lift and lower the head unit 11 and the maintenance device 30 between a normal position and a retracted position. When the image formation by the head unit 11 and maintenance by the maintenance device 30 are performed, the frame body 36F is positioned at the normal position (see FIG. 8A to FIG. 8B). When the sheet is jammed on the conveying belt 21, the frame body 36F is positioned at the retracted position (see FIG. 8H) to facilitate removal of the sheet, and the distance between the conveying belt 21 and the frame body 36F is increased.

Next, a basic operation of the maintenance device 30 will be described. In the initial state (see FIG. 8A), the frame body 36F is positioned at the normal position, the head unit 11 is positioned at the image forming position, and the cap unit 31 is positioned at the home position. The wipe unit 32 placed on the cap unit 31. That is, the waste liquid tray 81 is in contact with the caps 72. The control part 2 performs the following purge processing, wipe processing and cap mounting processing at a predetermined timing. The predetermined timing is, for example, a timing at which an increase in the viscosity of the ink in the nozzle 14N is expected, and specifically, a period in which the image forming job is not executed continues for a predetermined period.

First, the control part 2 operates the head lifting devices 11L to lift the head unit 11 to the retracted position (see FIG. 8B). Next, the control part 2 operates the cap sliding devices 34 to slide the cap unit 31 to the maintenance position (see FIG. 8C). At this time, since the wipe unit 32 is placed on the cap unit 31, the wipe unit 32 slides to the maintenance position together with the cap unit 31. Next, the control part 2 operates the head lifting devices 11L to lower the head unit 11 to a height at which the nozzle surface 14F is brought into contact with cleaning members 82 (see FIG. 7D).

Next, the control part 2 operates the inkjet head 12 to eject a predetermined amount of the ink from the inkjet head 12 forcibly (purge processing), supplies the cleaning liquid F to the nozzle surface 14F by the cleaning liquid supply device 13, and slides the cleaning members 82 along the nozzle surface 14F (wiping processing). Then, the remaining ink on the nozzle surface 14F is diluted by the cleaning liquid F, and the waste liquid W containing the remaining ink and the cleaning liquid F is scraped by the cleaning members 82 and falls into the recess 81U.

Next, the control part 2 operates the head lifting devices 11L to lift the head unit 11 to the retracted position (see FIG. 8C). Next, the control part 2 operates the cap sliding devices 34 to slide the cap unit 31 and the wipe unit 32 to the home position (see FIG. 8B).

Next, the control part 2 operates the wipe lifting devices 35 to lift the wipe unit 32 to the separated position (see FIG. 8E). Next, the control part 2 operates the cap sliding devices 34 to slide the cap unit 31 to the maintenance position (see FIG. 8F). At this time, since the wipe unit 32 is separated from the cap unit 31, the wipe unit 32 remains at the home position and only the cap unit 31 slides to the maintenance position.

Next, the control part 2 operates the head lifting devices 11L to lower the head unit 11 to a height at which the nozzle surface 14F is in contact with the caps 72 (see FIG. 8G). Thus, the caps 72 are mounted on the nozzle surface 14F (capping processing).

When the image forming job is executed, the control part 2 operates the head lifting devices 11L to lift the head unit 11 to the retracted position (see FIG. 8F), operates the cap sliding device 34 to slide the cap unit 31 to the home position (see FIG. 8E), and operates the wipe lifting devices 35 to lower the wipe unit 32 to the contact position (see FIG. 8B). Then, the control part 2 operates the head lifting devices 11L to lower the head unit 11 to the image forming position (see FIG. 8A), and executes the image forming job.

When the sheet is jammed between the conveying belt 21 and the frame body 36F during the image formation, the control part 2 operates the unit lifting devices 36 to lift the frame body 36F to the retracted position through the states of FIG. 8B, FIG. 8E, FIG. 8F and FIG. 8G (see FIG. 8H). When the user removes the jammed sheet and instructs the display operation part 19 to resume the image formation, the control part 2 operates the unit lifting devices 36 to lower the frame body 36F to the normal position (see FIG. 8G), lowers the head unit 11 to the image formation position (see FIG. 7A) through the states of FIG. 8F, FIG. 8E, and FIG. 8B, and resumes the image formation job.

[Cleaning liquid Penetration Device] As described above, the control part 2 performs the purging processing, the wiping processing, and the capping processing at the predetermined timing. The predetermined timing is, for example, a timing at which an increase in the viscosity of the ink in the nozzle 14N is expected, and specifically, a period in which the image forming job is not executed continues for a predetermined period.

However, even if the purging processing, the wiping processing, and the capping processing are performed at the predetermined timing, the ink not completely removed by the wiping processing may accumulate and deposit to the nozzle surface 14F. Further, in an environment with low humidity or when a large number of images with low image density are printed, the viscosity of the ink adhering to the nozzle surface 14F increases and the ink tends to deposit to the nozzle surface 14F. In preparation for such a case, in the present embodiment, the following cleaning liquid penetration device 40 is used.

For example, the cleaning liquid penetration device 40 may be used as a regular menu of regular maintenance performed by a serviceman. Further, when the ink is visually confirmed to be deposited to the nozzle surface 14F at the time of periodic maintenance, the cleaning liquid penetration device 40 may be used.

The cleaning liquid penetration device 40 may be incorporated into the maintenance device 30. Further, the cleaning liquid penetration device 40 may be configured as a device separate from the inkjet recording apparatus 1. In this case, a front door 3D (see FIG. 1) of the inkjet recording apparatus 1 may be opened, and after the head unit 11 is lifted to the retracted position (see FIG. 8B), the cleaning liquid penetration device 40 may be inserted below the head unit 11 for use.

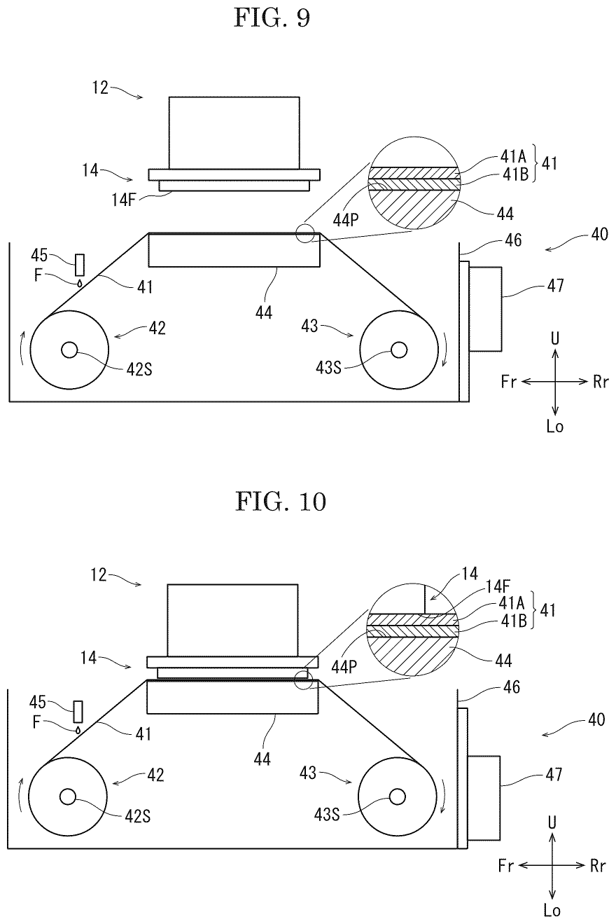

FIG. 9 and FIG. 10 are right side views schematically showing the cleaning liquid penetration device 40. The cleaning liquid penetration device 40 is provided with a rectangular parallelepiped housing 46 whose longitudinal direction is along the front-and-rear direction. A portion corresponding to the upper surface of the rectangular parallelepiped of the housing 46 is open. The housing 46 is provided with a feeding part 42, a winding part 43, a holding member 44, a cleaning liquid supply part 45, and a lifting device 47.

[Feeding Part, Impregnated Member] The feeding part 42 is provided in the lower front portion in the housing 46. The feeding part 42 includes a shaft 42S whose axial direction is along the left-and-right direction. Both left and right ends of the shaft 42S are supported by the housing 46. A belt-shaped impregnated member 41 is wound around the shaft 42S. The impregnated member 41 has a plurality of layers including a first layer 41A and a second layer 41B, and the first layer 41A is in contact with the nozzle surface 14F. The first layer 41A is made of material having liquid absorbency such as fabric or nonwoven fabric. The second layer 41B is made of material which does not allow liquid to pass through, such as film or metal foil.

[Winding Part] The winding part 43 is provided in the lower rear portion in the housing 46. The winding part 43 has a shaft 43S whose axial direction is along the left-and-right direction. Both left and right ends of the shaft 43S are supported by the housing 46. The impregnated member 41 fed from the feeding part 42 is wound around the shaft 43S. A driving force is transmitted to the shaft 43S from a driving part (not shown) including a motor, a reduction gear, and the like.

[Holding Member] The holding member 44 is a rectangular parallelepiped member whose longitudinal direction is along the front-and-rear direction. The holding member 44 is disposed between the feeding part 42 and the winding part 43 in the front-and-rear direction, is disposed above the feeding part 42 and the winding part 43 in the upper-and-lower direction, and is supported by the housing 46. The holding member 44 holds the impregnated member 41 between the feeding part 42 and the winding part 43 in a plane shape by a plane 44P facing the nozzle surface 14F.

The plane 44P of the holding member 44 is wider than the region 14R (see FIG. 7) provided with the ejection ports 14A (see FIG. 6) of the nozzle surface 14F. Specifically, a length L3 in the front-and-rear direction of the plane 44P is longer than a length L1 in the front-and-rear direction of the region 14R. A width W3 in the left-and-right direction of the plane 44P is wider than a width W1 in the left-and-right direction of the region 14R.

In the example of FIG. 7, the length L3 in the front-and-rear direction of the plane 44P is shorter than a length L2 in the front-and-rear direction of the nozzle surface 14F, but the length L3 may be equal to or larger than the length L2. In the example of FIG. 7, the width W3 in the left-and-right direction of the plane 44P is wider than a width W2 in the left-and-right direction of the nozzle surface 14F, but the width W3 may be less than or equal to the width W2.

The holding member 44 is made of material more flexible than the nozzle surface 14F, such as silicone rubber or urethane foam. Since the holding member 44 is more flexible than the nozzle surface 14F, when the holding member 44 is pressed against the nozzle surface 14F, the holding member 44 is elastically deformed while the nozzle surface 14F is not deformed. The holding member 44 is preferably made of material having no liquid absorbency, but may be formed by covering a material having liquid absorbency with a film (not shown) that does not allow liquid to pass through.

[Cleaning Liquid Supply Part] The cleaning liquid supply part 45 is, for example, a nozzle for ejecting the cleaning liquid F to the impregnated member 41. The cleaning liquid supply part 45 is arranged between the feeding part 42 and the holding member 44. When the ink is a water-based ink, the main component of the cleaning liquid F is water. A surfactant or the like may be added to the cleaning liquid F. The cleaning liquid supply part 45 may be any type as long as it supplies the cleaning liquid F to the impregnated member 41. For example, it may have a configuration in which the feeding part 42 is immersed in the cleaning liquid F stored in a liquid tank. Alternatively, it may have a configuration in which the cleaning liquid F is stored in a hollow roller having fine holes, and the roller is rubbed against the impregnated member 41 to apply the cleaning liquid F to the impregnated member 41.

[Lifting Device] The lifting device 47 lifts and lowers the housing 46. As the lifting device 47, a ball screw, a rack and pinion, a timing belt, or the like are used. The lifting device 47 lifts and lowers the housing 46 to a contact position at which the planar portion of the impregnated member 41 held by the holding member 44 is in contact with the nozzle surface 14F, and to a non-contact position at which the planar portion of the impregnated member 41 is not in contact with the nozzle surface 14F.

Next, an operation of a cleaning liquid penetration processing by the cleaning liquid penetration device 40 will be described. As an example, a case where the cleaning liquid penetration device 40 is configured as a device separate from the inkjet recording apparatus 1 will be described. The service man opens the front door 3D (see FIG. 1) of the inkjet recording apparatus 1, lifts the head unit 11 to the retracted position (see FIG. 8B), and then inserts the cleaning liquid penetration device 40 under the head unit 11. The operation of the cleaning liquid penetration device 40 described below may be performed by the serviceman operating the cleaning liquid penetration device 40, or may be performed by electrically connecting the cleaning liquid penetration device 40 to the inkjet recording apparatus 1 and controlling the cleaning liquid penetration device 40 by the control part 2.

The cleaning liquid penetration device 40 first feeds the impregnated member 41 by a predetermined length while supplying the cleaning liquid F from the cleaning liquid supply part 45 to the impregnated member 41 at the non-contact position. The predetermined length is, for example, a length in which the leading portion of the impregnated member 41 to which the cleaning liquid F is supplied from the cleaning liquid supply part 45 reaches the rear end portion of the plane 44P of the holding member 44. By this operation, the entire area of the planar portion of the impregnated member 41 held on the plane 44P of the holding member 44 is impregnated with the cleaning liquid F.

Next, the cleaning liquid penetration device 40 lifts the housing 46 to the contact position by the lifting device 47, and maintains the impregnated member 41 in contact with the nozzle surface 14F for a predetermined time. By this operation, the cleaning liquid F penetrates the ink deposited on to the nozzle surface 14F. Thereafter, the cleaning liquid penetration device 40 lowers the housing 46 to the non-contact position by the lifting device 47.

Next, the serviceman pulls out the cleaning liquid penetration device 40 from the inkjet recording apparatus 1, and closes the front door 3D. Next, the serviceman operates the display operation part 19 to cause the maintenance device 30 to execute the purge processing and the wiping processing described above. Thus, the ink deposited on the nozzle surface 14F is removed.

The cleaning liquid penetration processing may be performed a plurality of times before the purge processing and the wiping processing are performed. While the impregnated member 41 is in contact with the nozzle surface 14F, the impregnated member 41 may be fed while supplying the cleaning liquid F to the impregnated member 41 from the cleaning liquid supply part 45.

The cleaning liquid penetration device 40 according to the present embodiment described above includes the impregnated member 41 which is impregnated with the cleaning liquid F, and the holding member 44 which holds the impregnated member 41 in a planar shape and brings the planar-held portion of the impregnated member 41 into contact with the nozzle surface 14F of the inkjet head 12, wherein the holding member 44 is more flexible than the nozzle surface 14F. According to this configuration, since the holding member 44 pressed against the nozzle surface 14F is elastically deformed so as to bring the impregnated member 41 into close contact with the nozzle surface 14F, the cleaning liquid F can efficiently penetrate the ink deposited to the nozzle surface 14F. Since the holding member 44 is elastically deformed while the nozzle surface 14F is not deformed, the damage on the nozzle surface 14F can be suppressed.

According to the cleaning liquid penetration device 40 according to the present embodiment, the impregnated member 41 includes the layer (the second layer 41B) which does not allow liquid to pass through, between the impregnated member 41 and the holding member 44. According to this configuration, the outflow of the cleaning liquid F from the impregnated member 41 is suppressed.

According to the cleaning liquid penetration device 40 according to the present embodiment, the impregnated member 41 includes a plurality of layers including the first layer 41A having liquid absorbency and the second layer 41B which does not allow liquid to pass through, and the first layer 41A is brought into contact with the nozzle surface 14F. According to this configuration, the outflow of the cleaning liquid F from the impregnated member 41 is suppressed.

According to the cleaning liquid penetration device 40 according to the present embodiment, the plane 55P of the impregnated member 41 is wider than the region 14R where the ejection ports 14A of the nozzle surface 14F are provided. According to this configuration, since the impregnated member 41 impregnated with the cleaning liquid F is in surface contact with the entire region 14R of the nozzle surface 14F in which the ejection ports 14A are provided, the cleaning liquid F can efficiently penetrate the ink deposited to the nozzle surface 14F.

The inkjet recording apparatus 1 is provided with the cleaning liquid penetration device 40, the inkjet head 12, and the maintenance device 30 which removes the ink penetrated with the cleaning liquid F by the cleaning liquid penetration device 40 from the nozzle surface 14F of the inkjet head 12. According to this configuration, it is possible to suppress deterioration of image quality due to ejection failure or clogging of the inkjet head 12.

The above embodiment may be modified as follows.

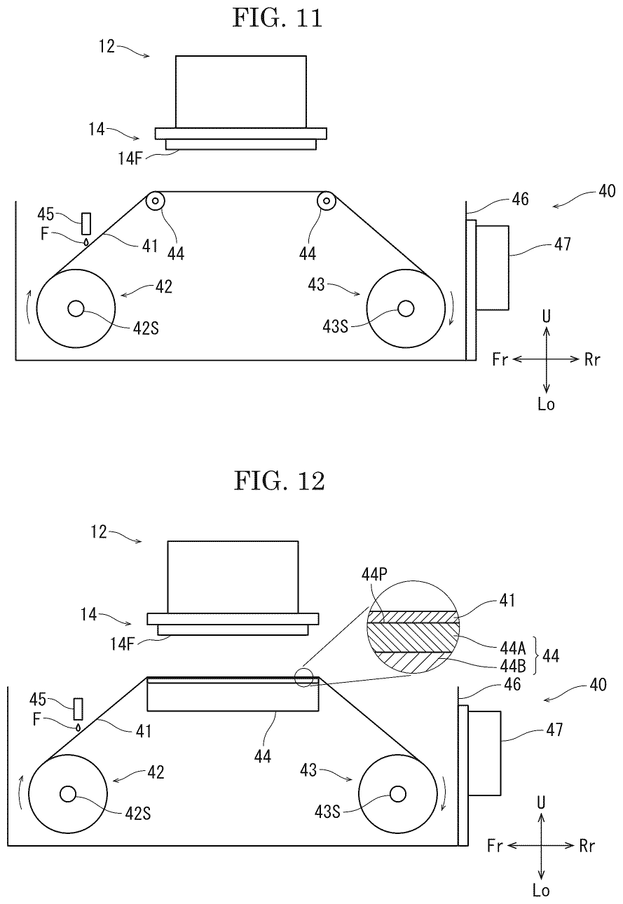

FIG. 11 is a right side view schematically showing the cleaning liquid penetration device 40 according to a modified example. In the above-described embodiment, the holding member 44 is a rectangular parallelepiped member whose longitudinal direction is along the front-and-rear direction, but the holding member 44 may be a pair of rollers. With this configuration, since the impregnated member 41 impregnated with the cleaning liquid F is brought into surface contact with the entire region 14R of the nozzle surface 14F where the ejection ports 14A are provided, the cleaning liquid F can be efficiently penetrated into the ink deposited on the nozzle surface 14F.

FIG. 12 is a right side view schematically showing the cleaning liquid penetration device 40 according to another modified example. In the above embodiment, the impregnated member 41 has a plurality of layers including the first layer 41A and the second layer 41B. The impregnated member 41 may include a single layer, and the holding member 44 may include a plurality of layers including the first layer 44A and the second layer 44B. In this case, the impregnated member 41 is made of material having liquid absorbency such as fabric or nonwoven fabric. The first layer 44A of the holding member 44 is made of material which does not allow liquid to pass through, such as film or metal foil, and the second layer 44B is made of material which is more flexible than the nozzle surface 14F, such as silicone rubber or urethane foam. The second layer 44B may be made of material having liquid absorbency. This configuration also suppresses the outflow of the cleaning liquid F from the impregnated member 41.

1. A cleaning liquid penetration device comprising:
an impregnated member which is impregnated with a cleaning liquid; and
a holding member which holds the impregnated member in a planar shape by a planer surface facing a nozzle surface of an inkjet head, and brings the planar-held portion of the impregnated member into contact with the nozzle surface, wherein
the holding member is more flexible than the nozzle surface.

2. The cleaning liquid penetration device according to claim 1, wherein
a layer which does not liquid to pass through is provided between the impregnated member and the holding member.

3. The cleaning liquid penetration device according to claim 2, wherein
the impregnated member includes a plurality of layers including a first layer having liquid absorbency and a second layer not allowing liquid to pass through, and
the first layer is brought into contact with the nozzle surface.

4. The cleaning liquid penetration device according to claim 1, wherein
the planer-held portion of the impregnated member is wider than a region where an ejection port is provided on the nozzle surface.

5. An inkjet recording apparatus comprising:
the cleaning liquid penetration device according to claim 1;
the inkjet head; and
a maintenance device which removes ink penetrated with the cleaning liquid by the cleaning liquid penetration device from the nozzle surface of the inkjet head.
